(19) United States
(12) Patent Application Publication
(10) Pub. No.: US 2022/0327612 A1
(43) Pub. Date: Oct. 13, 2022

(54) SYSTEM, APPARATUS AND METHOD FOR ASSISTING ONLINE AUCTION PROCESS

(71) Applicant: DUNAMU INC., Seoul (KR)

(72) Inventor: Jihoon LIM, Seoul (KR)

(73) Assignee: DUNAMU INC., Seoul (KR)

(21) Appl. No.: 17/674,465

(22) Filed: Feb. 17, 2022

(30) Foreign Application Priority Data
Apr. 9, 2021 (KR) 10-2021-0046355
Oct. 18, 2021 (KR) 10-2021-0138527

(51) Int. Cl. G06Q 30/08; G06Q 20/12

(52) U.S. Cl. CPC G06Q 30/08; G06Q 20/1235; G06Q 2220/00

(57) ABSTRACT

A system for providing an auction of goods with variable sales quantity is disclosed. In the system, an auction assisting device stores a non-fungible token (NFT) corresponding to a goods in a block chain network, receives a plurality of bid signals, each of which includes quantity information and price information for the goods, identifies valid bid signals, calculates a total sales amount of a respective valid bid signal by multiplying a sales quantity and a price of the respective valid bid signal, and selects a successful bid signal having a highest total sales amount, determines the sales quantity and the sale price of the successful bid signal as a final sales quantity and a final sale price, determines a successful bidder terminal corresponding to the successful bid signal, and provides the NFT to the successful bidder terminal.

The present application claims the benefit of priority to Korean Patent Application Nos. 10-2021-0046355, filed on Apr. 9, 2021, and 10-2021-0138527, filed on Oct. 18, 2021, in the Korean Intellectual Property Office. The disclosures of the above-listed applications are hereby incorporated by reference herein in their entirety.

### BACKGROUND

### 1. Field

Embodiments of the inventive concept described herein relate to an auction assisting system and method. More specifically, the embodiments described herein relate to a hardware system and a method to be performed by hardware devices, for assisting an auction for goods with a variable sales quantity, which is a factor affecting the scarcity value of the goods.

### 2. Description of the Related Art

Auction refers to the process of selling goods to a prospective bidder who has offered the best purchase conditions. That is, the traditional auction refers to a method of selling the goods to a bidder who has offered the highest price among bidders. In a traditional auction method, bidders offer a larger amount to purchase the goods.

Furthermore, today, digital goods such as images, video clips, audios, etc. are auctioned and digital goods are provided to successful bidders. In order to provide ownership of these digital goods to successful bidders, Non-Fungible Token (NFT) technology is sometimes used.

However, such an auction for digital goods is also based on the traditional auction method, and in many cases, the bidder who offered the maximum amount is selected as the successful bidder, and a NFT for the digital goods is provided to the successful bidder.

### SUMMARY

Embodiments of the inventive concept provide a system and a method for providing an auction of goods with variable sales quantity.

The purpose of the present disclosure is not limited thereto. Other purposes as not mentioned will be clearly understood by those skilled in the art from following descriptions.

According to an exemplary embodiment, a system provides an auction of goods with variable sales quantity. The system comprises a seller terminal that is hardware, a plurality of bidder terminals, each of which is hardware, and an auction assisting device that is hardware. The plurality of bidder terminals receive bid inputs from bidders, and the auction assisting device receives, from the plurality of bidder terminals, a plurality of bid signals, each of which includes quantity information and price information for the goods to be auctioned, identifies a plurality of valid bid signals among the plurality of bid signals, calculates a total sales amount of a respective valid bid signal of the plurality of valid bid signals by multiplying a sales quantity and a price of the respective valid bid signal, and selects at least one successful bid signal having a highest total sales amount among the plurality of valid bid signals, determines the sales quantity and the sale price of the at least one successful bid signal as a final sales quantity and a final sale price, determines at least one successful bidder terminal corresponding to the at least one successful bid signal, among the plurality of bidder terminals, stores at least one transaction which indicates the user of the bidder terminal which transmitted the successful bid signal owns a plurality of non-fungible tokens (NFTs) according to the final sales quantity, corresponding to the goods, in the block chain network.

According to an exemplary embodiment, a method assists an auction of goods with variable sales quantity. The method comprises receiving, by a plurality of bidder terminals, bid inputs from bidders; receiving, by the auction assisting device, from the plurality of bidder terminals, a plurality of bid signals, each of which includes quantity information and price information for the goods to be auctioned; identifying, by the auction assisting device, a plurality of valid bid signals among the plurality of bid signals; calculating, by the auction assisting device, a total sales amount of a respective valid bid signal of the plurality of valid bid signals by multiplying a sales quantity and a price of the respective valid bid signal, and selecting, by the auction assisting device, at least one successful bid signal having a highest total sales amount among the plurality of valid bid signals; determining, by the auction assisting device, the sales quantity and the sale price of the at least one successful bid signal as a final sales quantity and a final sale price; determining, by the auction assisting device, at least one successful bidder terminal corresponding to the at least one successful bid signal, among the plurality of bidder terminals; and storing at least one transaction which indicates the user of the bidder terminal which transmitted the successful bid signal owns a plurality of non-fungible tokens (NFTs) according to the final sales quantity, corresponding to the goods, in the block chain network.

Other features of the present disclosure are included in the detailed description and drawings.

### BRIEF DESCRIPTION OF THE DRAWINGS

The above and other objects and features will become apparent from the following description with reference to the following figures, wherein like reference numerals refer to like parts throughout the various figures unless otherwise specified, and wherein:

FIG. 1 is a diagram illustrating an auction assisting system according to some embodiments of the present disclosure;

FIG. 2 is a flowchart of an auction assisting method according to some embodiments of the present disclosure;

FIG. 3 is a diagram for describing step S140 described with reference to FIG. 2 in more detail;

FIGS. 4 to 6 and 8 illustrate various display status of the bid status;

FIG. 7 is a flowchart illustrating a method of displaying a bid status in a user terminal according to some embodiments of the present disclosure;

FIG. 9 is a diagram for describing another embodiment of step S140 described with reference to FIG. 2;

FIG. 10 is a diagram for describing step S150 described with reference to FIG. 2 in more detail; and

FIG. 11 is a diagram for describing step S170 described with reference to FIG. 2 in more detail.

FIG. 12 is an exemplary hardware configuration diagram that may implement a computing device in some embodiments of the present disclosure.

### DETAILED DESCRIPTION

Hereinafter, embodiments of the present disclosure will be described with reference to the attached drawings. Advantages and features of the present disclosure and methods of accomplishing the same may be understood more readily by reference to the following detailed description of embodiments and the accompanying drawings. The present disclosure may, however, be embodied in many different forms and should not be construed as being limited to the embodiments set forth herein. Rather, these embodiments may be provided so that this disclosure will be thorough and complete and will fully convey the concept of the disclosure to those skilled in the art, and the present disclosure will be defined by the appended claims.

In adding reference numerals to the components of each drawing, it should be noted that the same reference numerals may be assigned to the same components as much as possible even though they may be shown in different drawings. In addition, in describing the present disclosure, based on it being determined that the detailed description of the related well-known configuration or function may obscure the gist of the present disclosure, the detailed description thereof will be omitted.

Unless otherwise defined, all terms used in the present disclosure (including technical and scientific terms) may be used in a sense that can be commonly understood by those skilled in the art. In addition, the terms defined in the commonly used dictionaries may not be ideally or excessively interpreted unless they are specifically defined clearly. The terminology used herein may be for the purpose of describing embodiments and may not be intended to be limiting of the disclosure. In this disclosure, the singular also includes the plural unless specifically stated otherwise in the phrase.

In addition, in describing the component of this disclosure, terms, such as first, second, A, B, (a), (b), can be used. These terms may be for distinguishing the components from other components, and the nature or order of the components may not be limited by the terms. Based on a component being described as being “connected,” “coupled” or “contacted” to another component, that component may be directly connected to or contacted with that other component, but it should be understood that another component also may be “connected,” “coupled” or “contacted” between each component.

As used herein, the term “seller” may be construed to encompass not only a party who has provided goods for an auction and has received a price for selling the goods, but also a prospective seller who attempts a transaction with such intention. The goods may comprise digital goods such as images or video clips. Further, the goods may also comprise tangible objects such as paintings, sculptures or limited edition products.

As used herein, the term “bidder” may be construed to encompass not only a party participating in an auction to purchase goods, but also a prospective bidder who attempts to bid with such an intention.

As used herein, the term “user” may be construed to encompass both a bidder and a seller. Accordingly, the term “user terminal” may be construed to encompass either a seller terminal or a bidder terminal, which is a hardware device terminal, such as a mobile device.

Embodiments described in the present disclosure provide a hardware system and a method that provide a digital auction in which the number of successful bidders, the number of goods (in the case of NFT, the number of goods to be generated), and the successful bidding price are dynamically changed according to the collectively received biddings. This would maximize the willingness of auction participants to pay prices for acquiring a unique value.

Embodiments described herein may provide an auction assisting method and apparatus that breaks away from the traditional auction method.

Embodiments described herein may provide a method and apparatus for assisting an auction for goods with a variable sales quantity.

Embodiments described herein may provide an auction assisting method and apparatus for deriving a sales quantity and price that generate a maximum sales amount.

Embodiments described herein may provide an auction assisting method and apparatus that can share a stake of goods during an auction.

Embodiments described herein provide another method and apparatus thereof not mentioned above, and would be understood from the following description.

Hereinafter, some embodiments will be described in detail with reference to the accompanying drawings.

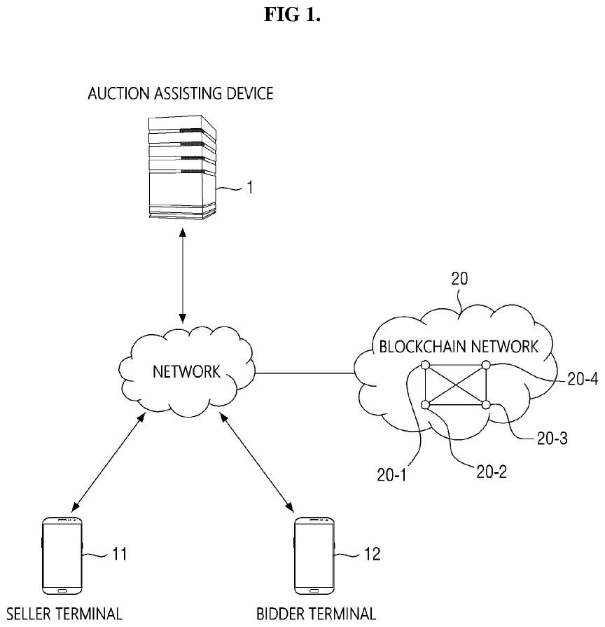

FIG. 1 is a diagram illustrating an auction assisting system according to some embodiments of the present disclosure.

Referring to FIG. 1, the auction assisting system according to some embodiments of the present disclosure includes a seller terminal 11 having a hardware configuration, a bidder terminal 12 having a hardware configuration, an auction assisting device 1 having a hardware configuration, and a blockchain network 20 that is accessible via a network by hardware devices. With the above configuration, the auction assisting system according to some embodiments of the present disclosure provides an auction of digital goods with variable sales quantity.

In some embodiments, the auction assisting device 1 is a hardware server that provides an online platform that relays an online auction of goods between seller hardware terminals and bidder hardware terminals. In some embodiments, the auction assisting device 1 stores user information such as ID and password, date of birth, gender, email address, mobile communication phone number, account number, and virtual wallet address of each of the bidder of the bidder hardware terminal and the seller of the seller hardware terminal.

In some embodiments, the auction assisting device 1 records auction posts including information on goods submitted in the auction, seller information, the minimum bid price of the goods, the range of the sales quantity of the goods, etc. on the server, and provide the auction posts to allow users of user hardware terminals in the online platform to view them. The auction assisting device 1 controls so that posts related to the auction target goods, a minimum bid price, and the like are exposed only to users who satisfy specific conditions, via user hardware terminals.

In some embodiments, the auction assisting device 1 supports an auction for goods whose sales quantity is variably determined.

In some embodiments, the auction assisting device 1 stores a non-fungible token (NFT) corresponding to the digital good in a block chain network, receives, from the plurality of bidder terminals, a plurality of bid signals, each of which includes quantity information and price information for the digital good, identifies a plurality of valid bid signals among the plurality of bid signals, calculates a total sales amount of a respective valid bid signal of the plurality of valid bid signals by multiplying a sales quantity and a price of the respective valid bid signal, and selects at least one successful bid signal having a highest total sales amount among the plurality of valid bid signals, determines the sales quantity and the sale price of the at least one successful bid signal as a final sales quantity and a final sale price, determines at least one successful bidder terminal corresponding to the at least one successful bid signal, among the plurality of bidder terminals, and provides the NFT to the at least one successful bidder terminal.

The above operations are modifiable. Thus, in some embodiments, the goods are digital-based goods including, for example, a digital image, a video clip, a game character, or a game item. The auction assisting device 1 obtains bids from a plurality of bidder terminals. The bid includes information on a sales quantity and a bid price of the goods. The auction assisting device 1 identifies a valid bid from among a plurality of obtained bids, identifies a bid having a maximum total sales amount calculated by multiplying a sales quantity and a price from among the valid bids, and selects as a successful bid.

In some embodiments, the auction assisting device 1 determines the sales quantity and price corresponding to the successful bid as the final sales quantity and the final sale price, and determines one or more bidders participating in the successful bid as the successful bidder. The auction assisting device 1 provides a non-fungible token (NFT) corresponding to the goods to the successful bidder. In addition, the auction assisting device 1 stores the NFT in association with the goods in a blockchain. The auction assisting device 1 propagates a transaction including the NFT and identification information of the goods to the blockchain network 200, and stores the NFT in a blockchain in association with the goods.

In some embodiments, the auction assisting device determines a particular bid signal, which has a particular sales quantity number, as a valid bid signal when a number of bid signals, each of which has the particular sales quantity number, is equal to or greater than the particular sales quantity number.

In some embodiments, the auction assisting device receives, from the seller terminal, information on a maximum allowable sales quantity, and the sales quantity of each of the plurality of bids is configured to be limited to less than or equal to the maximum allowable sales quantity.

In some embodiments, the auction assisting device receives a first bid signal including a first sales quantity and a first price from a first bidder terminal among the plurality of bidder terminals, and receives a second bid signal including a second sales quantity and a second price from a second bidder terminal among the plurality of bidder terminals. The auction assisting device distinguishes the first bid signal over the second bid signal when the first sales quantity and the second sales quantity are different, or when the first price and the second price are different, and identifies that the first bid signal and the second bid signal are the same bid when the first sales quantity and the second sales quantity are the same, and the first price and the second price are the same.

In some embodiments, the auction assisting device transmits, to a user terminal, information on the plurality of bid signals, and receives, from the user terminal, a participation request to a particular bid among bids of the plurality of bid signals.

In some embodiments, the auction assisting device generates a particular number of NFTs, which corresponds to the final sales quantity, and provides the NFTs to each of successful bidder terminals.

In some embodiments, the auction assisting device receives, from a user terminal, a participation request to a particular bid among bids of the plurality of bid signals, and denies the participation request when a participant number of the particular bid is satisfied.

In some embodiments, the auction assisting device receives, from an original bidder terminal, a sharing allowing message for a stake of the good, receives, from an additional bidder terminal, an additional bid that is identical to a bid of the original bidder terminal, and determines stakes of the original bidder terminal and the additional bidder terminal.

In some embodiments, the auction assisting device receives, from the additional bidder terminal, information on a requested stake, determines whether the requested stake is included in a preset allowed stake range, and determines the requested stake as a stake of the additional bidder terminal when the requested stake is included in the allowed stake range.

In some embodiments, the auction assisting device receives, from the original bidder terminal and the additional bidder terminal, price information for the stake of the good when both the original bidder terminal and the additional bidder terminal are selected as successful bidder terminals.

The above operations of the auction assisting device are further described and explained in the later parts of the present disclosure.

In some embodiments, the blockchain network 20 is a network formed, in which a plurality of nodes 20-1, 20-2, 20-3, and 20-4 participate, and each node 20-1, 20-2, 20-3, and 20-4 included in the blockchain network 20 share a blockchain with blocks connected to each other. In some embodiments, the block is composed of a block header and a transaction. In some embodiments, the block header includes a previous block identifier (e.g., hash), a markle root, a nonce, and/or a timestamp. In some embodiments, a transaction includes an NFT associated with goods. In some embodiments, the transaction includes identification information of a successful bidder (a successful bidder terminal) for the goods.

In some embodiments, the seller terminal 11 and the bidder terminal 12 are hardware devices which are controlled by the seller user and the bidder user, who are participating in an auction on an online platform provided by the auction assisting device 1. In some embodiments, the seller terminal 11 and the bidder terminal 12 include computing devices such as smartphones, tablet PCs, and laptop computers.

In some embodiments, the bidder terminal 12 is a computing device used by the bidder user to purchase an auction goods, and provides an interface for participating in a bid on an online platform provided by the auction assisting device 1 to a prospective purchaser. In some embodiments, the bidder terminal 12 participates in a plurality of bid for the same goods. In other words, in some situations, one bidder user participates in a plurality of different bids.

In some embodiments, the seller terminal 11 is a computing device used by a seller user who sells goods through an auction, and provides the seller with an interface for selling goods on an online platform provided by the auction assisting device 1. In some embodiments, according to the seller's input, the seller terminal 11 provides the goods sales information to the goods transaction assisting device 1 to register a post for auctioning the goods.

So far, an auction assisting system according to some embodiments of the present disclosure has been described with reference to FIG. 1. Hereinafter, an auction assisting method according to some embodiments of the present disclosure, which includes operations performed through the auction assisting device 1, the blockchain network 20, the seller terminal 11, and the purchaser terminal 12 are described.

According to some embodiments of the present disclosure, a method for a computing device to assist an auction of goods with variable sales quantity is provided.

In some embodiment, the method includes steps for transmitting, by a seller terminal that is hardware, an original file of a digital good to be auctioned, to an auction assisting device that is hardware; receiving, by a plurality of bidder terminals, bid inputs from bidders; storing, by the auction assisting device, a non-fungible token (NFT) corresponding to the digital good in a block chain network; receiving, by the auction assisting device, from the plurality of bidder terminals, a plurality of bid signals, each of which includes quantity information and price information for the digital good; identifying, by the auction assisting device, a plurality of valid bid signals among the plurality of bid signals; calculating, by the auction assisting device, a total sales amount of a respective valid bid signal of the plurality of valid bid signals by multiplying a sales quantity and a price of the respective valid bid signal, and selecting, by the auction assisting device, at least one successful bid signal having a highest total sales amount among the plurality of valid bid signals; determining, by the auction assisting device, the sales quantity and the sale price of the at least one successful bid signal as a final sales quantity and a final sale price; determining, by the auction assisting device, at least one successful bidder terminal corresponding to the at least one successful bid signal, among the plurality of bidder terminals; and providing, by the auction assisting device, the NFT to the at least one successful bidder terminal.

In some embodiment, the step of identifying includes determining a particular bid signal, which has a particular sales quantity number, as a valid bid signal when a number of bid signals, each of which has the particular sales quantity number, is equal to or greater than the particular sales quantity number.

In some embodiment, the method further includes receiving, by the seller terminal, information on a maximum allowable sales quantity, and limiting, by the auction assisting device, the sales quantity of each of the plurality of bids to less than or equal to the maximum allowable sales quantity.

In some embodiment, the step of the receiving the plurality of bid signals includes receiving a first bid signal including a first sales quantity and a first price from a first bidder terminal among the plurality of bidder terminals, and receiving a second bid signal including a second sales quantity and a second price from a second bidder terminal among the plurality of bidder terminals, distinguishing the first bid signal over the second bid signal when the first sales quantity and the second sales quantity are different, or when the first price and the second price are different, and identifying that the first bid signal and the second bid signal are the same bid when the first sales quantity and the second sales quantity are the same, and the first price and the second price are the same.

In some embodiment, the step of the receiving the plurality of bid signals includes transmitting, to a user terminal, information on the plurality of bid signals, and receiving, from the user terminal, a participation request to a particular bid among bids of the plurality of bid signals.

In some embodiment, the step of the providing the NFT includes generating a particular number of NFTs, which corresponds to the final sales quantity, and providing the NFTs to each of successful bidder terminals.

In some embodiment, the method further includes receiving, by the auction assisting device, from a user terminal, a participation request to a particular bid among bids of the plurality of bid signals, and denying, by the auction assisting device, the participation request when a participant number of the particular bid is satisfied.

In some embodiment, the method further includes receiving, by the auction assisting device, from an original bidder terminal, a sharing allowing message for a stake of the good, receiving, by the auction assisting device, from an additional bidder terminal, an additional bid that is identical to a bid of the original bidder terminal, and determining, by the auction assisting device, stakes of the original bidder terminal and the additional bidder terminal.

In some embodiment, the step of the determining the stakes includes receiving, from the additional bidder terminal, information on a requested stake, determining whether the requested stake is included in a preset allowed stake range, and determining the requested stake as a stake of the additional bidder terminal when the requested stake being included in the allowed stake range.

In some embodiment, the method further includes receiving, by the auction assisting device, from the original bidder terminal and the additional bidder terminal, price information for the stake of the good when both the original bidder terminal and the additional bidder terminal are selected as successful bidder terminals.

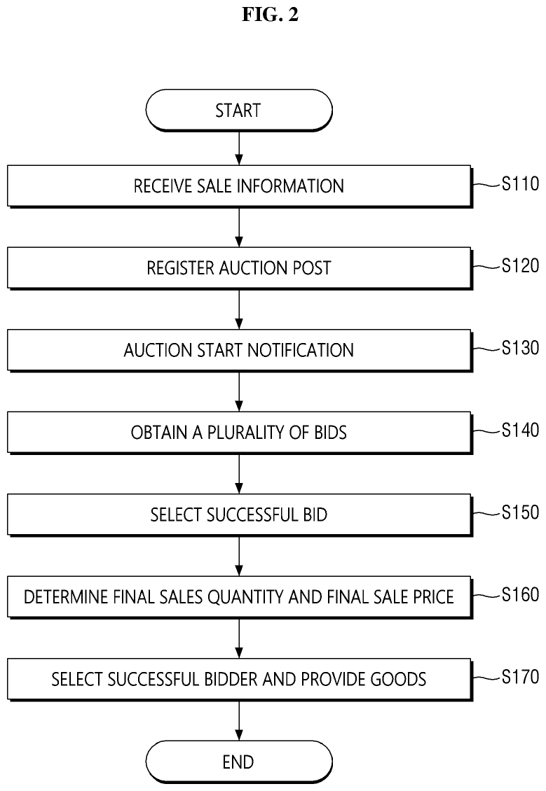

Hereinafter, with reference to FIGS. 2 to 11, the above method according to some embodiments of the present disclosure, which includes operations performed through the auction assisting device 1, the blockchain network 20, the seller terminal 11, and the purchaser terminal 12 are further described.

FIG. 2 is a flowchart of an auction assisting method according to some embodiments of the present disclosure.

Each step of the method shown in FIG. 2 is performed by a hardware computing device. In some embodiments, each step of the method is implemented with one or more instructions executed by a hardware processor of a hardware computing device. In some embodiments, the first steps included in the method is performed by the first computing device, and the second steps of the method is performed by the second computing device. Hereinafter, the description are continued assuming that each step of the method is performed by the auction assisting device 1 described with reference to FIG. 1, but the performing subject of each step is an example, and it is not limited thereto, and for convenience of description, descriptions of the operating subjects of some steps included in the method may be omitted.

Referring to FIG. 2, in some embodiments, the auction assisting device 1 receives sales information on goods to be auctioned, from the seller terminal 11 (S110). In some embodiments, the sale information includes one or more of an original file of the digital goods to be auctioned, identification information of the seller, account information of the seller, the maximum allowable sales quantity of the goods, the minimum sale price of the goods, and the like. As the seller's account information, in some embodiments, the seller's virtual wallet address is included, or the seller's bank account number is included.

Next, in some embodiments, the auction assisting device 1 determines the auction date and time of the goods and register auction posts including auction information of the goods (S120). In some embodiments, the auction post includes a minimum bid amount of the goods, seller information of the goods, information on the goods, and the like. In some embodiments, the auction assisting device 1 sets the minimum sales amount received from the seller terminal 11 as the minimum bid amount.

Next, in some embodiments, when the determined auction date and time arrives, the auction assisting device 1 transmits an auction start notification message to the plurality of bidder terminals 12 to inform that the auction of the goods has started (S130). In some embodiments, the auction assisting device 1 transmits the auction start notification message to bidders who have registered as interested users in the auction post.

Subsequently, the auction assisting device 1 in some embodiments obtains a plurality of bids from a plurality of bidders (S140), which include information on the quantity and price of the goods bid by the bidder.

In other words, in some embodiments, the sales quantity of the goods is variably determined within a range less than or equal to the maximum allowable sales quantity set by the seller, and the bidder bids on one or more sales quantities and prices among these variable sales quantities. That is, the auction assisting device 1 obtains the maximum allowable sales quantity from the seller, and the sales amount of each of the plurality of bids would be limited to less than or equal to the maximum allowable sales quantity.

In some embodiments, one bidder participates in several bids, and the auction assisting device 1 obtains a plurality of bids from a specific bidder. The plurality of bids are the same or different. For example, the auction assisting device 1 obtains a first bid from the first bidder, and obtains a second bid different from the first bid from the first bidder. At least one of a sales quantity and a sale price corresponding to each of the first bid and the second bid is different from each other, or the first bid and the second bid are the same.

In some other embodiments, the seller of the goods does not set a maximum allowable sales quantity, and in this case, the bidder would be able to bid on an arbitrary sales quantity and price.

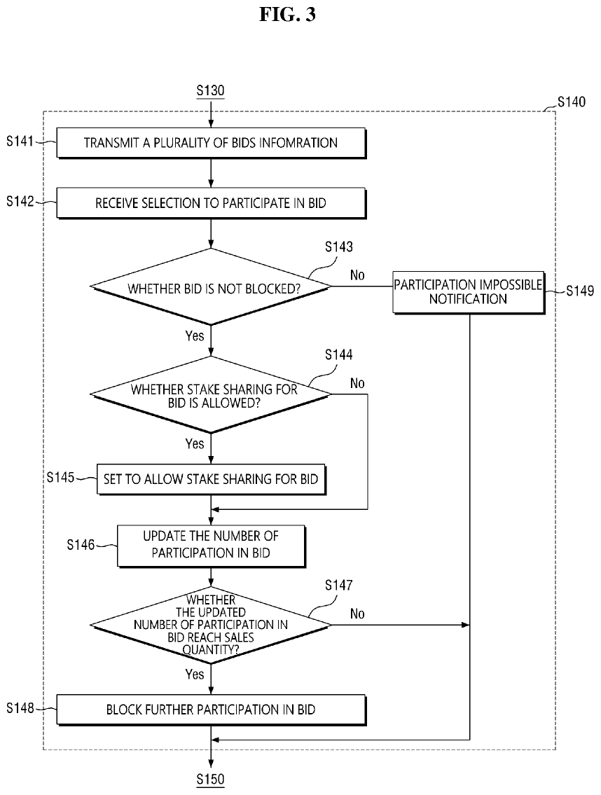

In some embodiments, the auction assisting device 1 transmits information on a plurality of pre-obtained bids to the bidder terminal 12, and receive a selection to participate in any one of the plurality of pre-obtained bids from the bidder terminal 12. An exemplary process for obtaining the plurality of bids is further described in more detail with reference to FIG. 3.

Next, in some embodiments, when the auction closing time arrives, the auction assisting device 1 divides the plurality of obtained bids into valid bids and invalid bids, identifies the bid with the maximum total sales amount calculated by multiplying the sales quantity and the price corresponding to each bid among the valid bids and selects as a successful bid (S150).

Next, the auction assisting device 1 in some embodiments determines the sales quantity and price corresponding to the successful bid as the final sales quantity and the final sale price (S160).

Subsequently, in some embodiments, one or more bidders participating in the successful bid is or are determined as a successful bidder(s), and goods are provided to the successful bidder(s) (S170).

According to the above-described operations of the embodiments, by selecting the bid that would generate the maximum profit from the seller's point of view as the successful bid, taking into account the sale price, the number of bidders, and the sales quantity for each bid, the goods sales profit through the auction can be maximized. In addition, according to the above-described operations of the embodiments, unlike the traditional auction method, by supporting an auction, in which the total sales quantity affecting the scarcity value of goods is not fixed but variable, and providing an opportunity that users who have offered a relatively low bid price also would be selected as successful bidders, it would have the effect of increasing the auction participation rate. In addition, unlike the existing auction method, in which the bidder would participate in only one bid, in this embodiment, a new auction method that allows the bidder to participate in a plurality of bids several times would be supported.

Hereinafter, step S140 described with reference to FIG. 2 is further described in more detail with reference to FIGS. 3 to 6.

Referring to FIGS. 2 to 6, in some embodiments, the auction assisting device 1 transmits a plurality of bids information to the seller terminal 11 and the bidder terminal 12 (S141). Each bid information in some embodiments includes a sales quantity and price specified for the bid. The seller terminal 11 and the bidder terminal 12 in some embodiments displays the status of a plurality of bids that can be participated in based on the plurality of bids information. A price that would be assigned to each bid would be determined by the auction assisting device 1 or would be determined according to a seller's input. Depending on the sales quantity, the bids would have different price range. As illustrated in FIG. 4, the price range of bids corresponding to the same goods quantity would be increased when the goods sales quantity is small and would be lowered when the goods sales quantity is large.

FIG. 4 is a diagram illustrating a displayed bid status, and the bidder terminal 12 in some embodiments displays the status of a plurality of bids based on the bid information received from the auction assisting device 1. Here, even if the sales quantity is the same, when the sale prices are different, they would be distinguished as different bids from each other. In addition, even if they have the same sale price, when the sales quantity is different, they would be distinguished as different bids from each other. For example, when obtaining a first bid including a first sales quantity and a first price from a first bidder and obtaining a second bid including a second sales quantity and a second price from a second bidder, if the first sales quantity and the second sales quantity are different or the first price and the second price are different, it would be determined that the first bid and the second bid are different bids that are distinguished from each other. Referring to FIG. 4 as an example, six bids having the sales quantity of ‘1’ and different prices are displayed distinguished from each other. On the other hand, the bids with the sale price of ‘800’ are duplicated, but as the sales quantities are different from ‘4’ and ‘5,’ the bid with the sale price of ‘800’ and the sales quantity of ‘4’ and the bid with the sale price of 800’ and the sales quantity of ‘5’ are distinguished from each other. The sale price would be a price expressed in terms of the quantity of virtual assets.

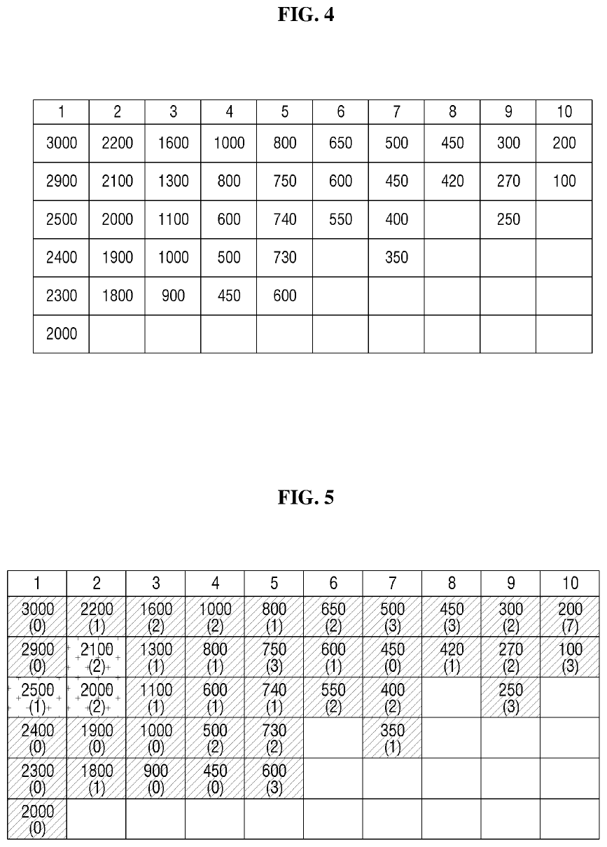

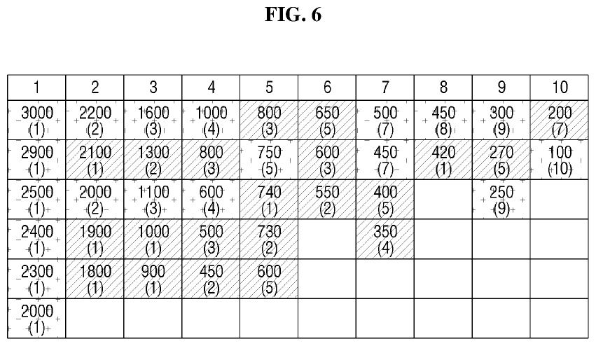

In addition, in some embodiments, each bid information includes the number of bidders participating in the corresponding bid, and the bidder terminal 12 displays bids including the number of participating bidders. FIG. 5 is a diagram illustrating bids including the number of participating bidders, and a number in parentheses in FIG. 5 would indicate the number of bidders participating in a bid.

Referring back to FIG. 3, in some embodiments, the auction assisting device 1 receives a selection to participate in at least one bid from one or more bidder terminals 12 (S142). Next, the auction assisting device 1 in some embodiments determines whether the selected bid has been blocked from participation (S143). When the number of bid participation for the selected bid reaches the sales quantity specified for the bid, the bid would be blocked from participation, and if the number of bid participation for the selected bid is less than the sales quantity of the bid, the bid would not be blocked from participation. Here, the number of bid participation indicates the number of bidders participating in the corresponding bid.

In some embodiments, the auction assisting device 1 transmits a message indicating that participation in the bid is impossible to the bidder terminal 12 based on the determination that the bid has been blocked from participation (S149).

On the other hand, in some embodiments, if it is determined that the bid is not blocked from participation, the auction assisting device 1 determines whether the bidder has allowed the sharing of the stake for the bid (S144). When the bidder selects to participate in the bid, the bidder determines whether to allow the sharing of the stake, and the auction assisting device 1 checks whether the stake sharing is allowed for the bid selected according to the input of the bidder terminal 12. In some embodiments, the auction assisting device 1 receives a range, in which the stake sharing is allowed, from the bidder terminal 12 when the bidder allows the stake sharing.

Subsequently, the auction assisting device 1 in some embodiments sets a bid as a bid that allows stake sharing based on a determination that the stake sharing for the bid is allowed (S145). In this case, the auction assisting device 1 in some embodiments stores the stake shareable range received from the bidder in association with the bid.

Next, the auction assisting device 1 in some embodiments updates the number of bidders participating in the bid by increasing the number of participation in the selected bid (S146). Subsequently, the auction assisting device 1 in some embodiments determines whether the updated number of participation in the bid has reached the sales quantity of the bid (S147). As a result of the determination, if the updated number of participation in the bid reaches the sales quantity of the bid, further participation in the bid would be blocked (S148). In the event that further participation in the bid is blocked, further bids would be impossible for the bid. However, bidders would be able to participate in bids, in which further participation is blocked, through stake sharing as described later with reference to FIG. 9.

If the number of participation in a bid is changed, the auction assisting device 1 in some embodiments transmits the changed number of participation in bids to the seller terminal 11 and the bidder terminal 12 to update the bids displayed in the seller terminal 11 and the bidder terminal 12.

When obtaining a plurality of bids having the same sales quantity and the same price, the auction assisting device 1 in some embodiments identifies bidders participating in the plurality of bids as bidders participating in the same bid. For example, when the auction assisting device 1 obtains the third bid including the first sales quantity and the first price from the third bidder, and obtains the first bid including the first sales quantity and the first price from the first bidder, the first bidder and the third bidder would be identified as bidders participating in the same bid.

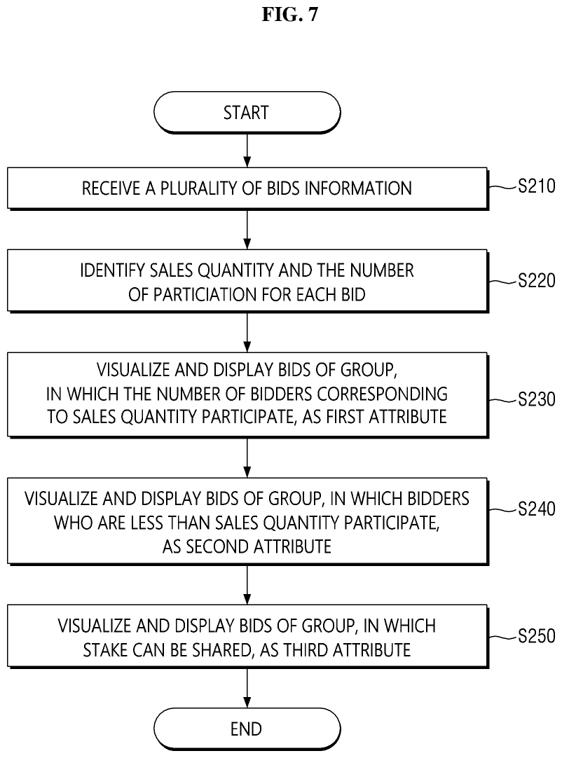

FIG. 6 is a diagram illustrating changed bids compared to FIG. 5. In some embodiments, as participation is added to each bid, the number in parentheses (i.e., the number of bidders participating in the bid) is updated.

On the other hand, in some embodiments shown in FIGS. 5 and 6, bids that have been blocked from further participation and bids that would be participated in would be visually processed as different attributes and displayed on the seller terminal 11 and the bidder terminal 12.

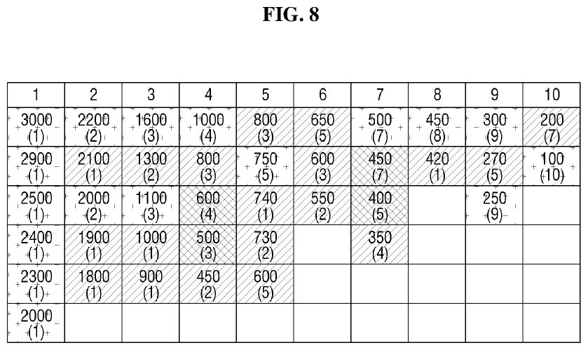

FIG. 7 is a flowchart illustrating a method of displaying bids in a user terminal according to some embodiments of the present disclosure.

Each step of the method illustrated in FIG. 7 would be performed by a hardware computing device. In other words, each step of the method would be implemented with one or more instructions executed by a hardware processor of a hardware computing device. In some embodiments, the first steps included in the method are performed by the first computing device, and the second steps of the method are performed by the second computing device. Hereinafter, the description is continued assuming that each step of the method is performed by the seller terminal 11 and the bidder terminal 12 described with reference to FIG. 1, and the performing subject of each step is an example, but is not limited thereto, and for convenience of description, descriptions of the operating subjects of some steps included in the method are omitted.

Referring to FIG. 7, the seller terminal 11 and the bidder terminal 12 in some embodiments receive a plurality of bids information including a sales quantity, a price, and a participation number from the auction assisting device 1 (S210). In some embodiments, the bid information additionally includes information on whether a stake would be shared.

Subsequently, the seller terminal 11 and the bidder terminal 12 in some embodiments identify the sales quantity, price, and participation number (i.e., the number of bidders) for each bid based on the plurality of bids information, and determine whether a stake would be shared in the bid. (S220). In some embodiments, the seller terminal 11 and the bidder terminal 12 display information on a plurality of bids in two dimensions. The seller terminal 11 and the bidder terminal 12 in some embodiments display each sales quantity corresponding to each of the plurality of bids on one axis, and arrange and display bids corresponding to the same sales quantity among the plurality of bids in the order of sale price.

The seller terminal 11 and the bidder terminal 12 in some embodiments visualize and display the bids of the first group, in which bidders corresponding to the sales quantity corresponding to each bid participate, as a first attribute (S230). In addition, the seller terminal 11 and the bidder terminal 12 in some embodiments visualize and display the bids of the second group, in which the number of bidders less than the sales quantity corresponding to each bid participate, as a second attribute (S240).

The seller terminal 11 and the bidder terminal 12 in some embodiments visualize and display the bids of the third group, in which a stake can be shared, as a third attribute (S250).

As illustrated in FIGS. 5, 6 and 8, the bids in some embodiments are divided into three groups, and each group is visualized and displayed as different attributes. Here, the group, in which the plurality of ‘+’ sign patterns are displayed on the background, corresponds to the first group, the group, in which the diagonal pattern is displayed on the background, corresponds to the second group, and the group, in which the crossed diagonal pattern is displayed on the background, corresponds to the third group.

In some embodiments, the above described visualizing and displaying are automatically processed in real-time, by a hardware processor of the auction assisting device 1 based on bidding information received from the seller terminal 11 and the bidder terminal 12. The auction assisting device 1 transmits visualizing and displaying instructions to the seller terminal 11 and the bidder terminal 12.

According to the above-described operations of the embodiments, by visualizing and displaying the participable bids, non-participable bids, and stake sharable bids differently from each other, it is possible to exert an effect of improving the user's convenience when participating in an auction.

Hereinafter, some embodiments of step S140 described with reference to FIG. 2 are further described in detail with reference to FIG. 9.

Referring to FIG. 9, the auction assisting device 1 in some embodiments transmits a plurality of bids information to the seller terminal 11 and the bidder terminal 12 (S1141). In some embodiments, each bid information includes information on the sales quantity, the price, the number of participation, and whether a stake would be shared in the bid.

Subsequently, the auction assisting device 1 in some embodiments receives a stake sharing request for a stake sharable bid from the bidder terminal 12 (S1142). Next, the auction assisting device 1 in some embodiments receives the stake requested by the bidder from the bidder terminal 12 (S1143).

Next, the auction assisting device 1 in some embodiments identifies the allowed stake range set for the bid (S1144), and determines whether the stake requested by the bidder (hereinafter, referred to as ‘requested stake’) is included in the identified allowed stake range (S1145).

In response to the determination that the requested stake is included in the allowed stake range, the auction assisting device 1 in some embodiments determines the stake between a plurality of bidders for the bid (S1146). For example, if the fifth bidder requests 20% of the stake in the bid while the fourth bidder allows the stake sharing for the bid, the fourth bidder's stake in the bid would be determined to be 80%, and the fifth bidder's stake would be determined to be 20%. When a bid, in which a stake is set between a plurality of users, is successful, a stake in the single goods would be determined between the plurality of users.

Meanwhile, when the requested share is not included in the allowed stake range in step S1145, the auction assisting device 1 in some embodiments transmits a message indicating that the stake sharing is impossible to the bidder terminal 12 (S1147).

According to the above-described operations of the embodiments, by enabling a bid with a small amount through stake sharing, it is possible to exert the effect of allowing more users to participate in the auction.

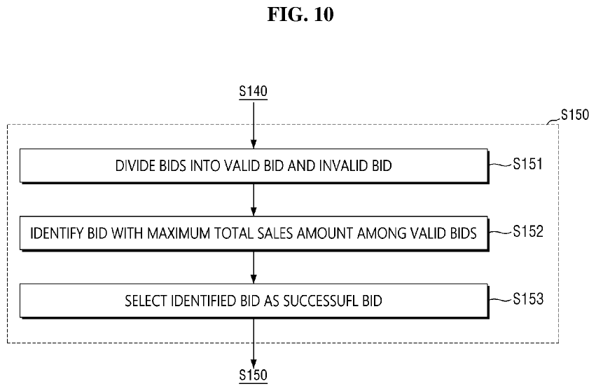

Hereinafter, some embodiments of step S150 described with reference to FIG. 2 are further described in more detail with reference to FIG. 10.

Referring to FIG. 10, the auction assisting device 1 in some embodiments classifies a plurality of bids obtained through participation of a bidder into valid bids and invalid bids (S151). Here, the valid bids are bids, in which bidders corresponding to the sales quantity specified for each bid participate. In addition, invalid bids are bids, in which the bidders participate in a number that is less than the sales quantity specified for the bid.

Subsequently, the auction assisting device 1 in some embodiments identifies the bid with the maximum total sales amount from among the valid bids (S152). In some embodiments, the auction assisting device 1 calculates a total sales amount by multiplying a sales quantity and a price for each of the valid bids, and identifies a bid having the maximum total sales amount calculated. Next, the auction assisting device 1 in some embodiments identifies a bid having the identified maximum total sales amount as a successful bid (S153).

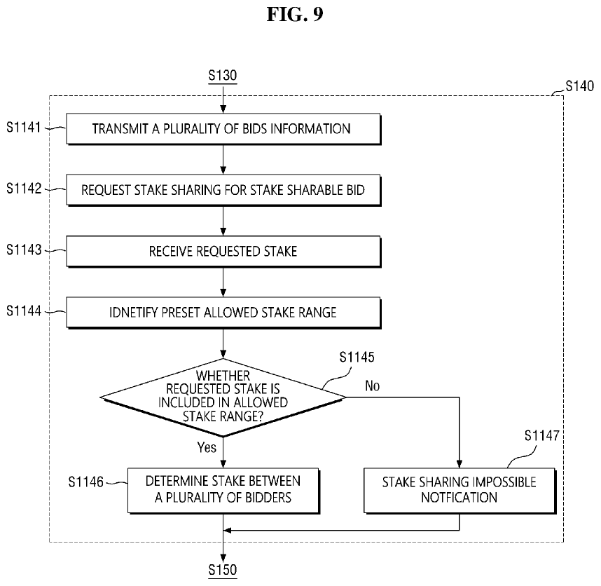

When the bid is completed in the state shown in FIG. 8, the bid with the sales quantity of ‘3’ and the price of ‘1600’ among the valid bids generates the largest total sales amount (i.e., 4800), and accordingly, the bid with the sales quantity of ‘3’ and the price of ‘1600’ would be determined as a successful bid.

According to the above-described operations of the embodiments, by selecting a bid generating the maximum sales amount from among the bids as the successful bid, it is possible to generate the maximum profit at the time of the auction.

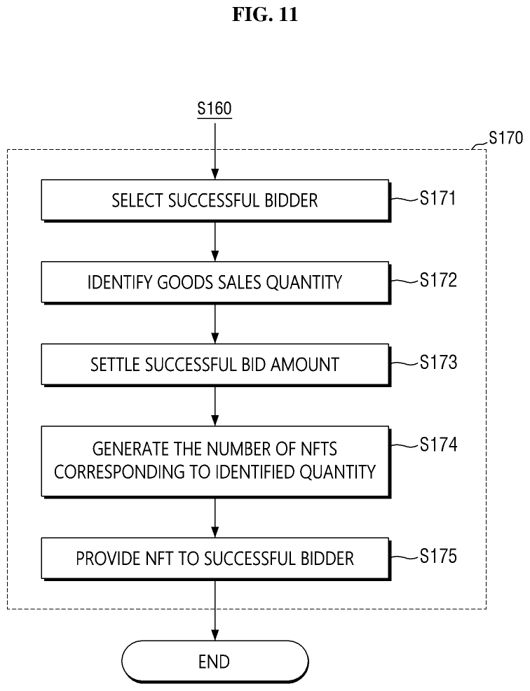

Hereinafter, some embodiments of step S170 described with reference to FIG. 2 are further described in more detail with reference to FIG. 11.

Referring to FIG. 11, when a successful bid is selected, one or more bidders participating in the successful bid is or are selected as a successful bidder(s) (S171). Subsequently, the auction assisting device 1 in some embodiments identifies the goods sales quantity and price corresponding to the successful bid (S172).

The auction assisting device 1 in some embodiments settles the successful bid amount by receiving a successful bid amount corresponding to the price of the goods from each successful bidder and providing the seller with an amount excluding the commission from the successful bid amount (S173). The auction assisting device 1 in some embodiments receives the virtual asset corresponding to the successful bid amount from the successful bidder, and provides the seller with an amount excluding the commission from the virtual asset. In this case, the auction assisting device 1 propagates a transaction related to the movement of the virtual asset to the blockchain network 20.

Next, the auction assisting device 1 in some embodiments generates the number of NFTs corresponding to the identified quantity (S174). The NFT in some embodiments is generated using a known ERC (Ethereum Request for Comment)-721.

The auction assisting device 1 in some embodiments provides the generated NFT to each successful bidder (S175). In some embodiments, the auction assisting device 1 stores the NFT in a blockchain in association with the goods.

On the other hand, the auction assisting device 1 in some embodiments sets the stake of one goods for each successful bidder based on the shared stake, and provides the set stake of the goods to the successful bidders when stake sharing is set for a successful bid. For example, when the stake of the fourth bidder for the successful bid is 80% and the stake of the fifth bidder is 20%, the stake of the fourth bidder for one goods would be set to 80% and provided to the fourth bidder, and the stake of the fifth bidder would be set to 20% and provided to the fifth bidder. The auction assisting device 1 in some embodiments propagates a transaction including unique identification information, NFT, and stake information for goods to the blockchain network 20 and stores the transaction in the blockchain.

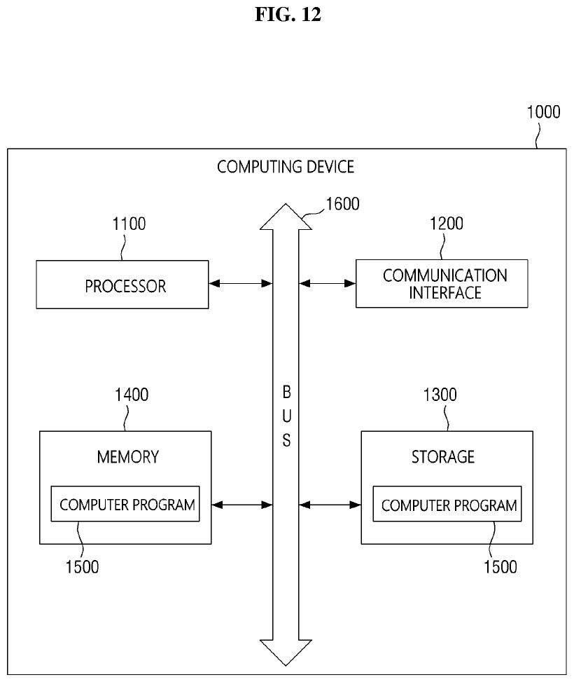

Hereinafter, an exemplary hardware computing device that would implement an apparatus and a system, according to various embodiments is described with reference to FIG. 12.

FIG. 12 is an exemplary hardware configuration diagram that would implement a computing device in various embodiments. As shown in FIG. 12, the computing device 1000 in some embodiments includes one or more of processor 1100, a hardware system bus 1600, a hardware communication interface 1200, a hardware memory 1400, which loads a computer program 1500 executed by the processor 1100, and a hardware storage 1300 for storing the computer program 1500. FIG. 12 illustrates the components related to some embodiment of the present disclosure. It would be appreciated by those skilled in the art that the present disclosure may further include other general purpose components in addition to the components shown in FIG. 12.

The processor 1100 controls overall operations of each component of the computing device 1000. The processor 1100 is configured to include at least one of a Central Processing Unit (CPU), a Micro Processor Unit (MPU), a Micro Controller Unit (MCU), a Graphics Processing Unit (GPU), or any type of processor well known in the art. Further, the processor 1100 performs calculations on at least one application or program for executing a method/operation according to various embodiments of the present disclosure. The computing device 1000 in some embodiments has one or more processors.

The memory 1400 store various data, instructions and/or information. The memory 1400 loads one or more programs 1500 from the storage 1300 to execute methods/operations according to various embodiments of the present disclosure. An example of the memory 1400 is a RAM, but may not be limited thereto.

The bus 1600 provides communication between components of the computing device 1000. The bus 1600 is implemented as various types of bus such as an address bus, a data bus and a control bus. The communication interface 1200 supports wired and wireless internet communication of the computing device 1000. The communication interface 1200 supports various communication methods other than internet communication. To this end, the communication interface 1200 is configured to comprise a communication module well known in the art of the present disclosure. The storage 1300 in some embodiments is a non-temporarily storage storing one or more computer programs 1500. The storage 1300 is configured to include a non-volatile memory, such as a Read Only Memory (ROM), an Erasable Programmable ROM (EPROM), an Electrically Erasable Programmable ROM (EEPROM), a flash memory, a hard disk, a removable disk, or any type of computer readable recording medium well known in the art.

The computer program 1500 includes one or more instructions, on which the methods/operations according to various embodiments of the present disclosure are practically implemented. Based on the computer program 1500 being loaded on the memory 1400, the processor 1100 practically perform the methods/operations in accordance with various embodiments by executing the one or more instructions.

The computer program 1500 in some embodiments includes instructions for performing operations including obtaining a plurality of bids from a plurality of bidders, wherein the bids include a sales quantity and price of goods, and identifying a bid having a maximum total sales amount calculated by multiplying a sales quantity and a price corresponding to each bid among valid bids to select as a successful bid, and determining a sales quantity and price corresponding to the successful bid as a final sales quantity and a final sale price, and determining one or more bidders participating in the successful bid as a successful bidder.

Many aspects of the disclosure are described in terms of sequences of actions to be performed by elements of a computer system or other hardware capable of executing programmed instructions, for example, a general-purpose computer, special purpose computer, workstation, or other programmable data process apparatus. It will be recognized that in each of the embodiments, the various actions could be performed by specialized circuits (e.g., discrete logic gates interconnected to perform a specialized function), by program instructions (software), such as program modules, being executed by one or more processors (e.g., one or more microprocessors, a central processing unit (CPU), and/or application specific integrated circuit), or by a combination of both. For example, embodiments can be implemented in hardware, software, firmware, microcode, or any combination thereof. The instructions can be program code or code segments that perform necessary tasks and can be stored in a non-transitory machine-readable medium such as a storage medium or other storage(s). A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents.

It should be understood that these modules and units are merely described based on their function for clarity purposes, and do not necessarily represent specific hardware or software. In this regard, these modules, units, and other components may be hardware implemented, such as by a processor, a computer having a processor, a controller having a processor, electronic circuitry, etc. and/or software stored on non-transitory computer-readable media, as described herein, that may be uploaded to the hardware and implemented to substantially perform their particular functions explained herein. The various functions of the different components can be combined or segregated as hardware and/or software modules in any manner, and can be useful separately or in combination. Input/output or I/O devices or user interfaces including, but not limited to, keyboards, displays, pointing devices, and the like can be coupled to the system either directly or through intervening I/O controllers. Thus, the various aspects of the disclosure may be embodied in many different forms, and all such forms are contemplated to be within the scope of the disclosure.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device. The non-transitory machine-readable medium can additionally be considered to be embodied within any tangible form of computer readable carrier, such as solid-state memory, magnetic disk, and optical disk containing an appropriate set of computer instructions, such as program modules, and data structures that would cause a processor to carry out the techniques described herein. A computer-readable medium may include the following: an electrical connection having one or more wires, magnetic disk storage, magnetic cassettes, magnetic tape or other magnetic storage devices, a portable computer diskette, a random access memory (RAM), a read-only memory (ROM), an erasable programmable read-only memory (e.g., EPROM, EEPROM, or Flash memory), or any other tangible medium capable of storing information. It should be noted that the system of the present disclosure is illustrated and discussed herein as having various modules and units that perform particular functions.

In the above description, it may be described that all the components constituting the embodiments of the present disclosure may be combined or operated as one, but the technical features of the present disclosure may not be limited to these embodiments. That is, within the scope of the present disclosure, all of the components may be selectively combined and operated in one or more combinations.

Although the operations may be shown in an order in the drawings, those skilled in the art will appreciate that many variations and modifications can be made to the embodiments without substantially departing from the principles of the present disclosure. The disclosed embodiments of the disclosure may be used in a generic and descriptive sense and not for purposes of limitation. The scope of protection of the present disclosure should be interpreted by the following claims, and all technical ideas within the scope equivalent thereto should be construed as being included in the scope of the technical idea defined by the present disclosure.

What is claimed is:

1. A system for providing an auction of goods with variable sales quantity, the system comprising:
a seller terminal that is hardware;
a plurality of bidder terminals, each of which is hardware; and
an auction assisting device that is hardware, wherein:
the plurality of bidder terminals receive bid inputs from bidders;
the auction assisting device
receives, from the plurality of bidder terminals, a plurality of bid signals, each of which includes quantity information and price information for the goods to be auctioned,
identifies a plurality of valid bid signals among the plurality of bid signals,
calculates a total sales amount of a respective valid bid signal of the plurality of valid bid signals by multiplying a sales quantity and a price of the respective valid bid signal, and selects at least one successful bid signal having a highest total sales amount among the plurality of valid bid signals,
determines the sales quantity and the sale price of the at least one successful bid signal as a final sales quantity and a final sale price,
determines at least one successful bidder terminal corresponding to the at least one successful bid signal, among the plurality of bidder terminals, and
stores at least one transaction which indicates the user of the bidder terminal which transmitted the successful bid signal owns a plurality of non-fungible tokens (NFTs) according to the final sales quantity, corresponding to the goods, in the block chain network.

2. The system of claim 1, wherein the auction assisting device determines a particular bid signal, which has a particular sales quantity number, as a valid bid signal when a number of bid signals, each of which has the particular sales quantity number, is equal to or greater than the particular sales quantity number.

3. The system of claim 1, wherein the auction assisting device receives, from the seller terminal, information on a maximum allowable sales quantity, and the sales quantity of each of the plurality of bids is configured to be limited to less than or equal to the maximum allowable sales quantity.

4. The system of claim 1, wherein the auction assisting device receives a first bid signal including a first sales quantity and a first price from a first bidder terminal among the plurality of bidder terminals, and receives a second bid signal including a second sales quantity and a second price from a second bidder terminal among the plurality of bidder terminals, and
wherein the auction assisting device distinguishes the first bid signal over the second bid signal when the first sales quantity and the second sales quantity are different, or when the first price and the second price are different, and identifies that the first bid signal and the second bid signal are the same bid when the first sales quantity and the second sales quantity are the same, and the first price and the second price are the same.

5. The system of claim 1, wherein the auction assisting device transmits, to a user terminal, information on the plurality of bid signals, and receives, from the user terminal, a participation request to a particular bid among bids of the plurality of bid signals.

6. The system of claim 1, wherein the auction assisting device generates a particular number of NFTs, which corresponds to the final sales quantity, and provides the NFTs to each of successful bidder terminals.

7. The system of claim 1, wherein the auction assisting device receives, from a user terminal, a participation request to a particular bid among bids of the plurality of bid signals, and denies the participation request when a participant number of the particular bid is satisfied.

8. The system of claim 1, wherein the auction assisting device receives, from an original bidder terminal, a sharing allowing message for a stake of the goods, receives, from an additional bidder terminal, an additional bid that is identical to a bid of the original bidder terminal, and determines stakes of the original bidder terminal and the additional bidder terminal.

9. The system of claim 8, wherein the auction assisting device receives, from the additional bidder terminal, information on a requested stake, determines whether the requested stake is included in a preset allowed stake range, and determines the requested stake as a stake of the additional bidder terminal when the requested stake is included in the allowed stake range.

10. The system of claim 8, wherein the auction assisting device receives, from the original bidder terminal and the additional bidder terminal, price information for the stake of the goods when both the original bidder terminal and the additional bidder terminal are selected as successful bidder terminals.

11. A method for a computing device to assist an auction of goods with variable sales quantity, the method comprising:
receiving, by a plurality of bidder terminals, bid inputs from bidders;
receiving, by the auction assisting device, from the plurality of bidder terminals, a plurality of bid signals, each of which includes quantity information and price information for the goods to be auctioned;
identifying, by the auction assisting device, a plurality of valid bid signals among the plurality of bid signals;
calculating, by the auction assisting device, a total sales amount of a respective valid bid signal of the plurality of valid bid signals by multiplying a sales quantity and a price of the respective valid bid signal, and selecting, by the auction assisting device, at least one successful bid signal having a highest total sales amount among the plurality of valid bid signals;
determining, by the auction assisting device, the sales quantity and the sale price of the at least one successful bid signal as a final sales quantity and a final sale price;
determining, by the auction assisting device, at least one successful bidder terminal corresponding to the at least one successful bid signal, among the plurality of bidder terminals; and
storing at least one transaction which indicates the user of the bidder terminal which transmitted the successful bid signal owns a plurality of non-fungible tokens (NFTs) according to the final sales quantity, corresponding to the goods, in the block chain network.

12. The method of claim 11, wherein the identifying comprises:
determining a particular bid signal, which has a particular sales quantity number, as a valid bid signal when a number of bid signals, each of which has the particular sales quantity number, is equal to or greater than the particular sales quantity number.

13. The method of claim 11, further comprises,
receiving, by the seller terminal, information on a maximum allowable sales quantity; and
limiting, by the auction assisting device, the sales quantity of each of the plurality of bids to less than or equal to the maximum allowable sales quantity.

14. The method of claim 11, wherein the receiving the plurality of bid signals comprises:
receiving a first bid signal including a first sales quantity and a first price from a first bidder terminal among the plurality of bidder terminals, and receiving a second bid signal including a second sales quantity and a second price from a second bidder terminal among the plurality of bidder terminals;
distinguishing the first bid signal over the second bid signal when the first sales quantity and the second sales quantity are different, or when the first price and the second price are different; and
identifying that the first bid signal and the second bid signal are the same bid when the first sales quantity and the second sales quantity are the same, and the first price and the second price are the same.

15. The method of claim 11, wherein the receiving the plurality of bid signals comprises:
transmitting, to a user terminal, information on the plurality of bid signals; and
receiving, from the user terminal, a participation request to a particular bid among bids of the plurality of bid signals.

16. The method of claim 11, wherein the providing the NFT comprises:
generating a particular number of NFTs, which corresponds to the final sales quantity, and providing the NFTs to each of successful bidder terminals.

17. The method of claim 11, further comprises,
receiving, by the auction assisting device, from a user terminal, a participation request to a particular bid among bids of the plurality of bid signals, and denying, by the auction assisting device, the participation request when a participant number of the particular bid is satisfied.

18. The method of claim 11, further comprises,
receiving, by the auction assisting device, from an original bidder terminal, a sharing allowing message for a stake of the goods;
receiving, by the auction assisting device, from an additional bidder terminal, an additional bid that is identical to a bid of the original bidder terminal; and
determining, by the auction assisting device, stakes of the original bidder terminal and the additional bidder terminal.

19. The method of claim 18, wherein the determining the stakes comprises:
receiving, from the additional bidder terminal, information on a requested stake;
determining whether the requested stake is included in a preset allowed stake range; and
determining the requested stake as a stake of the additional bidder terminal when the requested stake being included in the allowed stake range.

20. The method of claim 18, further comprises:
receiving, by the auction assisting device, from the original bidder terminal and the additional bidder terminal, price information for the stake of the goods when both the original bidder terminal and the additional bidder terminal are selected as successful bidder terminals.
